(19) United States
(12) Patent Application Publication
(10) Pub. No.: US 2018/0063339 A1
(43) Pub. Date: Mar. 1, 2018

(54) IMAGE FORMING APPARATUS AND IMAGE FORMING SYSTEM

(71) Applicant: KYOCERA Document Solutions Inc., Osaka (JP)

(72) Inventors: Carl Christian Ray PANTIN, Osaka (JP); Kenth Remon CRISOLO, Osaka (JP)

(73) Assignee: KYOCERA Document Solutions Inc., Osaka (JP)

(21) Appl. No.: 15/263,600

(22) Filed: Sep. 13, 2016

(30) Foreign Application Priority Data
Sep. 1, 2016 (JP) 2016-171015

(51) Int. Cl. H04N 1/00; G06K 15/02

(52) U.S. Cl. CPC H04N 1/00037; G06K 15/027; H04N 1/00076; H04N 1/00063; H04N 1/00045

(57) ABSTRACT

An image forming apparatus includes: a print target data acquisition section that acquires print target data; a printing section; an actual printed image acquisition section that reads a recording paper sheet subjected to printing of the image forming section to acquire an actual printed image; a prospective image creating section that creates a prospective image expected to be provided by the printing on the image forming apparatus; an image comparing section that compares the actual printed image with the prospective image to calculate a comparison result indicating a difference of the actual printed image from the prospective image in terms of a predetermined item related to printing quality of the image forming section; and an output section that outputs the comparison result regarding the item calculated by the image comparing section.

### INCORPORATION BY REFERENCE

This application claims priority to Japanese Patent Application No. 2016-171015 filed on Sep. 1, 2016, the entire contents of which are incorporated by reference herein.

### BACKGROUND

The present disclosure relates to image forming apparatuses and image forming systems and particularly relates to a technique for detecting the printing quality of an image forming apparatus.

In relation to image forming apparatuses, techniques for detecting the image quality of prints are proposed. For example, one technique is proposed of reading images printed on a plurality of print media by an image forming apparatus from the print media and comparing them with each other to determine a poorly printed region. For another example, another technique is proposed of comparing an image scanned from an actual print with an image scanned from a test print to examine a variation in color shade.

### SUMMARY

A technique improved over the aforementioned techniques is proposed as one aspect of the present disclosure.

An image forming apparatus according to an aspect of the present disclosure includes a print target data acquisition section, a printing section, an actual printed image acquisition section, a prospective image creating section, an image comparing section, and an output section.

The print target data acquisition section acquires print target data from an information processing apparatus.

The printing section performs printing on a recording medium based on the print target data acquired by the print target data acquisition section.

The actual printed image acquisition section reads an image from the recording medium on which the printing has been performed by the printing section and acquires the read image as an actual printed image.

The prospective image creating section creates from the print target data a prospective image expected to be provided by printing on the image forming apparatus.

The image comparing section compares the actual printed image acquired by the actual printed image acquisition section with the prospective image created by the prospective image creating section to calculate a comparison result indicating a difference of the actual printed image from the prospective image in terms of a predetermined item related to printing quality of the printing section.

The output section outputs the comparison result regarding the item calculated by the image comparing section.

An image forming system according to an aspect of the present disclosure includes an information processing apparatus and the image forming apparatus.

The information processing apparatus includes a print target data sending section, a comparison result receiving section, and a display device.

The print target data sending section sends the print target data to the image forming apparatus.

The comparison result receiving section receives the comparison result from the image forming apparatus.

The display device displays the comparison result received by the comparison result receiving section.

### BRIEF DESCRIPTION OF THE DRAWINGS

FIG. 1 is a perspective view showing the appearances of an image forming apparatus and an information processing apparatus in an image forming system according to an embodiment of the present disclosure.

FIG. 2 is a block diagram showing the configurations of the image forming apparatus and the information processing apparatus in the image forming system according to the above embodiment.

FIG. 3 is a flowchart showing a flow of processing performed on the information processing apparatus when the image forming system performs print processing.

FIG. 4 is a flowchart showing a flow of processing performed on the image forming apparatus when the image forming system performs the print processing.

FIG. 5 is a view showing an operation screen displayed on a display section.

FIG. 6 is a flowchart showing processing for comparing an actual printed image and a prospective image performed by an image comparing section.

FIG. 7 is a diagram showing an example of a determination table for use in calculating the overall degree of achievement.

FIG. 8 is a flowchart showing a flow of processing performed on the information processing apparatus when the image forming system performs the print processing.

FIG. 9 is a diagram showing an example of a correspondence table of overall degrees of achievement versus messages.

FIG. 10 is a view showing a result display screen displayed on the display section.

FIG. 11 is a flowchart showing print processing of the image forming apparatus performed after a piece of processing in S57 shown in FIG. 4.

### DETAILED DESCRIPTION

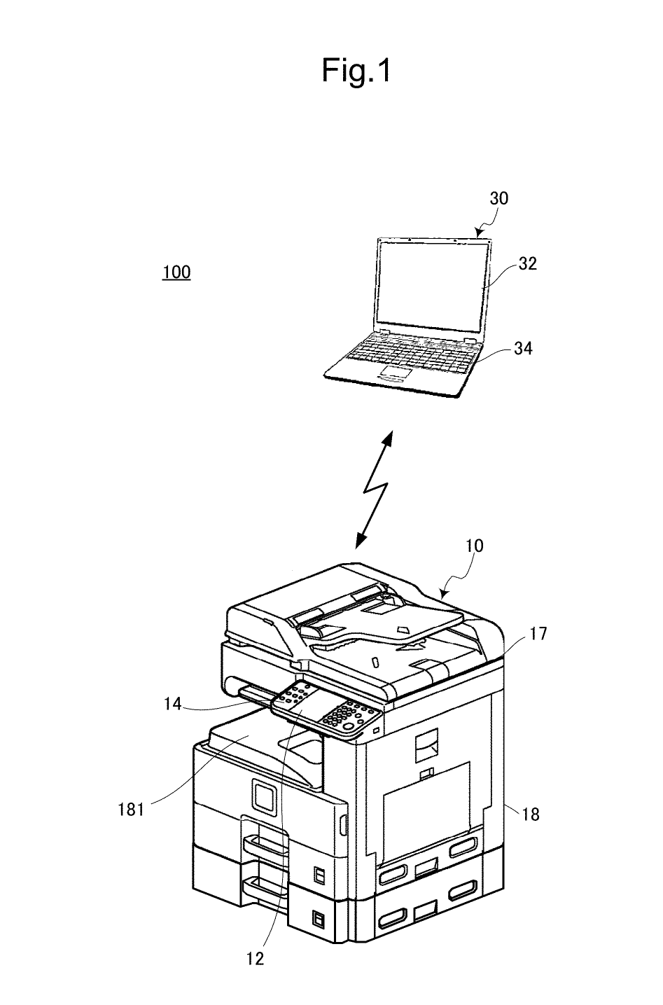

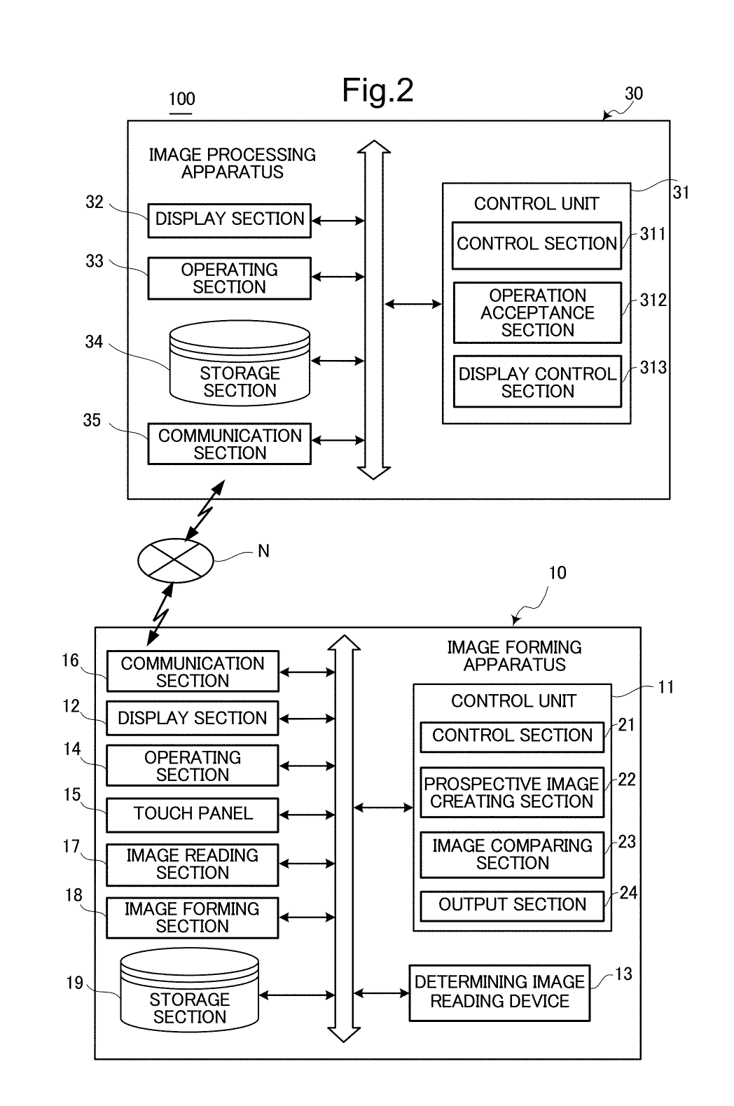

Hereinafter, a description will be given of an image forming apparatus and an image forming system both according to one embodiment of the present disclosure with reference to the drawings. FIG. 1 is a perspective view showing the appearances of the image forming apparatus and an information processing apparatus in the image forming system according to the embodiment of the present disclosure. FIG. 2 is a block diagram showing the configurations of the image forming apparatus and the information processing apparatus in the image forming system according to this embodiment.

The image forming system 100 according to this embodiment includes an image forming apparatus 10 and an information processing apparatus 30. The image forming apparatus 10 includes a control unit 11, a display section 12, an operating section 14, a touch panel 15, a communication section 16, an image reading section 17, an image forming section 18, a storage section 19, and a determining image reading device 13. These components are capable of data or signal transfer via a bus among them.

The image reading section 17 is, for example, a CCD serving as a scanner for optically reading an original document and has the function of generating image data representing an image of the original document. Furthermore, the image reading section 17 is a general reader for reading an original document being conveyed by an auto document feeder or an original document placed on a flatbed.

The determining image reading device 13 (an example of the actual printed image acquisition section) is provided in the interior of an apparatus body of the image forming apparatus 10. The determining image reading device 13 optically reads a recording paper sheet downstream of the image forming section 18 in the direction of conveyance in which the recording paper sheet is discharged, and generates image data representing an image of the recording paper sheet. The determining image reading device 13 is, for example, a scanner, such as a CIS scanner. The determining image reading device 13 is disposed, for example, in a conveyance path along which a recording paper sheet (an example of the recording medium) subjected to printing by the image forming section 18 (an example of the printing section, inclusive of a fixing device) is discharged from the image forming section 18 to a discharge section 181 (see FIG. 1) and near a discharge port where the recording paper sheet is discharged from the interior of the apparatus body to the discharge section 181. The determining image reading device 13 is disposed in a side of the apparatus body where it can read a side of the printed recording paper sheet on which an image has been first formed. The determining image reading device 13 outputs an image read from the recording paper sheet as an actual printed image to an image comparing section 23.

The image forming section 18 uniformly charges the surface of each photosensitive drum, exposes the surface of the photosensitive drum to form an electrostatic latent image on the surface of the photosensitive drum, develops the electrostatic latent image into a toner image, transfers the toner image (the image) on the surface of the photosensitive drum to a recording paper sheet, and fixes the toner image on the recording paper sheet. For example, the image forming section 18 prints, on the recording paper sheet, an image shown by print target data which the communication section 16 (an example of the print target data acquisition section) has received from the information processing apparatus 30.

The display section 12 is formed of a liquid crystal display (LCD), an organic light-emitting diode (OLED) display or the like.

The operating section 14 is designed to accept entry of instructions on various operations from a user and includes various keys, such as a menu key for calling up a menu, arrow keys for moving the focus of a GUI forming the menu, a determination key for performing a determination operation for the GUI forming the menu, and a start key.

The communication section 16 is a communication interface including a communication module and has the function of sending and receiving data to and from the information processing apparatus 30 via a network N formed of a LAN, a public line or the like.

The storage section 19 is a large storage device, such as an HDD (hard disk drive).

The control unit 11 is formed of a processor, a RAM (random access memory), a ROM (read only memory), and so on. The processor is, for example, a CPU (central processing unit), an MPU or an ASIC. When a control program stored in the above storage section 19 is executed by the above processor, the control unit 11 functions as a control section 21, a prospective image creating section 22, an image comparing section 23, and an output section 24. Alternatively, each of the control section 21, the prospective image creating section 22, the image comparing section 23, and the output section 24 of the control unit 11 may not be implemented by the operation of the control unit 11 in accordance with the above control program but may be constituted by a hardware circuit.

The control section 21 governs the overall operation control of the image forming apparatus 10.

The prospective image creating section 22 creates, from the print target data which the communication section 16 has received from the information processing apparatus 30, a prospective image expected to be provided by the printing on the image forming section 18. For example, when the communication section 16 receives from the information processing apparatus 30 print target data converted into a predetermined page-description language (such as a PCL) for the image forming apparatus 10, the control section 21 converts the print target data into raster data and allows the image forming section 18 to perform printing using the raster data. The prospective image creating section 22 acquires the raster data on a page-by-page basis and creates a prospective image of each page.

The image comparing section 23 compares an actual printed image represented by an image read by the determining image reading device 13 with a prospective image created by the prospective image creating section 22 to calculate a comparison result indicating a difference of the actual printed image from the prospective image in terms of at least one predetermined item related to printing quality of the image forming section 18.

For example, the image comparing section 23 calculates the comparison result by quantifying a difference of the actual printed image from the prospective image serving as a reference in terms of each of items: color shade, image defect, and degree of inclination.

The image comparing section 23 analyzes, on the page-by page basis, the color shade based on the actual printed image. For example, the image comparing section 23 detects, for each of color components CMYK, the pixel values of all the pixels constituting an actual printed image of one page. Furthermore, the image comparing section 23 calculates, for each color component, an average pixel value of all the pixels. Likewise, the image comparing section 23 calculates, for each of the color components, an average pixel value of all the pixels constituting a prospective image. Then, for each of the color components, the image comparing section 23 calculates the difference between the average pixel value of the actual printed image and the average pixel value of the prospective image and determines the color shade of the color component to be appropriate (1) when the difference is equal to or smaller than a predetermined threshold value or to be inappropriate (0) when the difference is larger than the threshold value. These appropriateness determination results are indicated, for example, as C=1, M=0, Y=0, K=0.

In detecting the degree of image defect, the image comparing section 23 extracts, from the pixels contained in the actual printed image of one page, any defective pixel satisfying the conditions that its pixel value is within a predetermined range of values where the pixel cannot form a dot and that the pixel value of a corresponding pixel in the prospective image is outside the predetermined range of values. Only when a predetermined plural number of pixels satisfying the above conditions are continued in the x or y direction, the image comparing section 23 may extract pixels constituting the above group of pixels as defective pixels. The image comparing section 23 calculates, as the comparison result indicating the above difference regarding the degree of image defect, a numerical value indicating the percentage of the number of extracted defective pixels in the total number of pixels constituting the actual printed image.

In determining the degree of inclination, for example, the image comparing section 23 detects, from the actual printed image, a straight line representing one edge of a read original document by edge detection or other techniques and calculates the angle of the straight line formed with a predetermined reference line as the comparison result indicating the degree of inclination.

Furthermore, the image comparing section 23 determines the item-specific degree of achievement regarding each of all the items, or specifically, determines the appropriateness of the actual printed image with reference to the prospective image based on whether or not the numerical value indicating the comparison result of each item reaches a threshold value preset for the item. More specifically, when the numerical value indicating the comparison result is equal to or smaller than the preset threshold value, the image comparing section 23 determines that the actual printed image is appropriate (1). On the other hand, when the numerical value is larger than the preset threshold value, the image comparing section 23 determines that the actual printed image is inappropriate (0).

As for the item-specific degree of achievement regarding the item of color shade, if the number of determination results of “inappropriate (0)” out of the four appropriateness determination results for the four color components CMYK is equal to or larger than a predetermined value (for example, three), the image comparing section 23 determines the item-specific degree of achievement as inappropriate (0). If not, the image comparing section 23 determines the item-specific degree of achievement as appropriate (1).

Furthermore, the image comparing section 23 determines, on the basis of the item-specific degrees of achievement regarding the above plurality of items, the image quality level (overall degree of achievement) of the printing based on the actual printed image. For example, the image comparing section 23 assigns to the above items their respective weighting factors for use in determining the image quality level, multiplies the respective item-specific degrees of achievement by the respective assigned factors, and calculates as the image quality level the sum of the multiplied values of the item-specific degrees of achievement. Hereinafter, the image quality level is referred to as the overall degree of achievement and detailed.

The control section 21 controls the display section 12 to allow the display section 12 to display an entry screen for entering setting items necessary for image formation processing or an entry screen for entering information. For example, the control section 21 allows the display section 12 to display the above comparison results, item-specific degrees of achievement, overall degree of achievement, and so on obtained by the image comparing section 23.

The communication section 16 sends and receives, under the control of the control section 21, various data including print target data to and from the information processing apparatus 30 via a LAN.

On the other hand, the information processing apparatus 30 is, for example, a personal computer. The information processing apparatus 30 includes, a control unit 31, a display section 32, an operating section 33, a storage section 34, and a communication section 35. These components are capable of data or signal transfer via a bus among them.

The display section 32 is formed of an LCD, an OLED display or the like.

The operating section 33 is composed of a keyboard, a pointing device, and so on.

The communication section 35 is a communication interface including a communication module and performs data communication via a network N formed of a LAN, a public line or the like.

The storage section 34 is a large storage device, such as an HDD.

The control unit 31 is formed of a processor, a RAM, a ROM, and so on. The processor is, for example, a CPU, an MCU or an ASIC. When a printer driver stored in the storage section 34 is executed by the above processor, the control unit 31 functions as a control section 311, an operation acceptance section 312, and a display control section 313. Alternatively, each constituent section of the control unit 31 may not be implemented by the operation of the control unit 31 in accordance with the above printer driver but may be constituted by a hardware circuit.

The control section 311 governs the overall operation control of the information processing apparatus 30.

The operation acceptance section 312 identifies, based on the operation performed through the operating section 33, a user's operation entered by the user. Then, the operation acceptance section 312 accepts the identified user's operation and outputs a control signal corresponding to the user's operation to the control section 311, the display control section 313, and so on.

The display control section 313 controls the display section 32 to allow various types of windows and so on to be displayed on the screen of the display section 32.

The control section 311 has the function of controlling the communication operation of the communication section 35. For example, the communication section 35 sends and receives, under the control of the control section 311, data to and from the image forming apparatus 10 via a LAN.

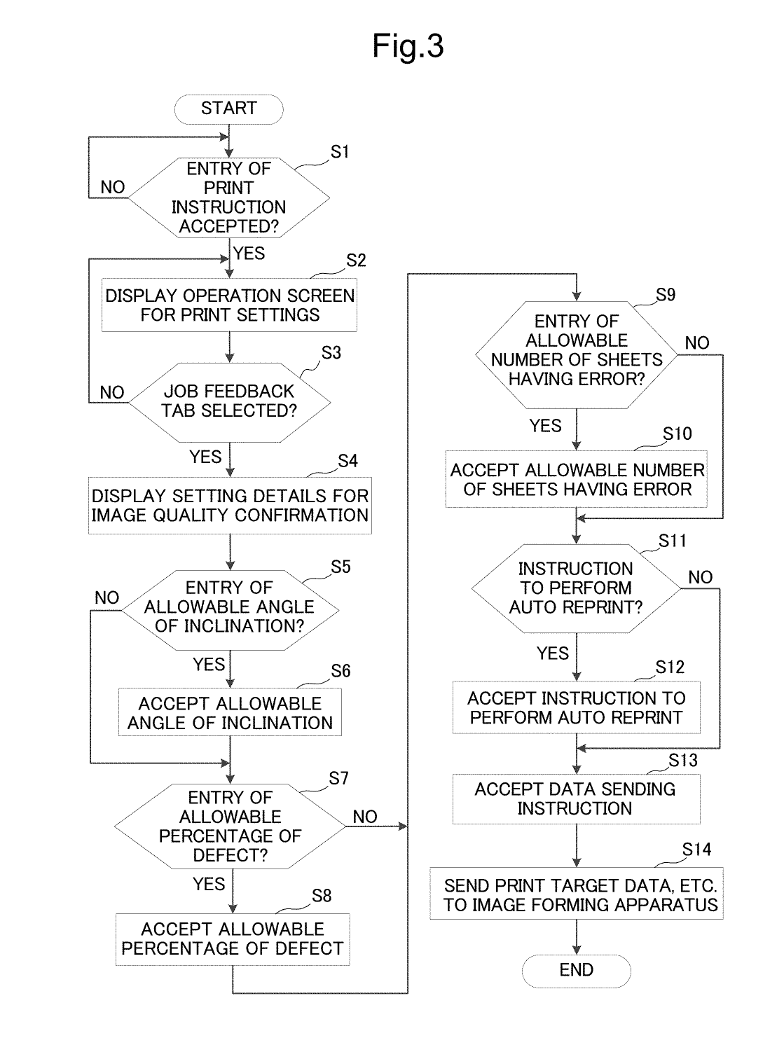

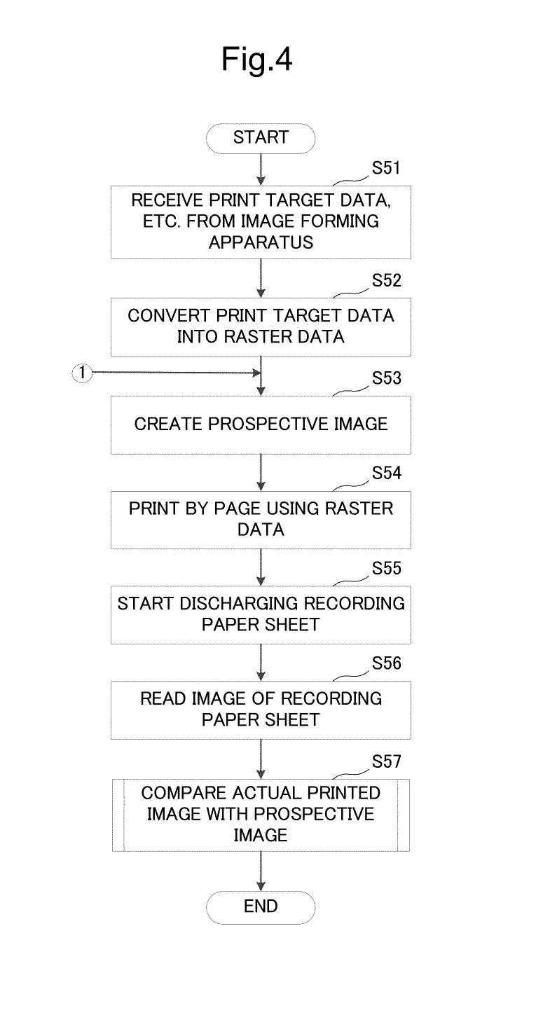

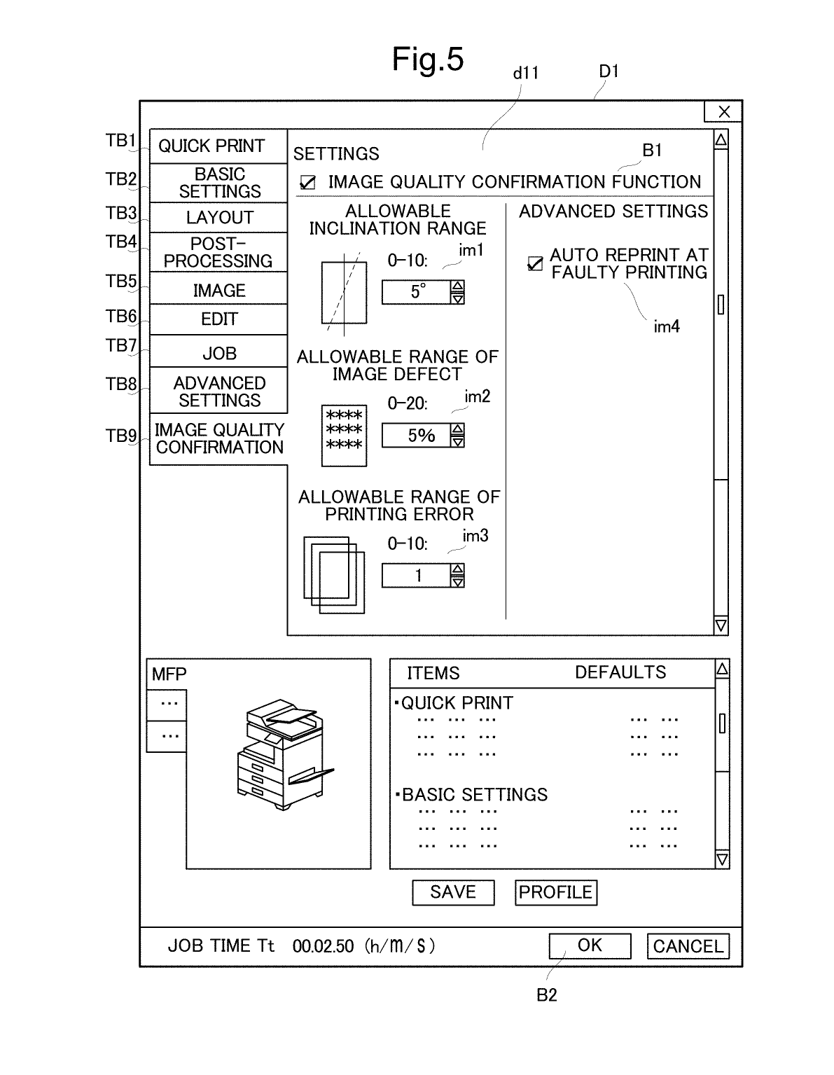

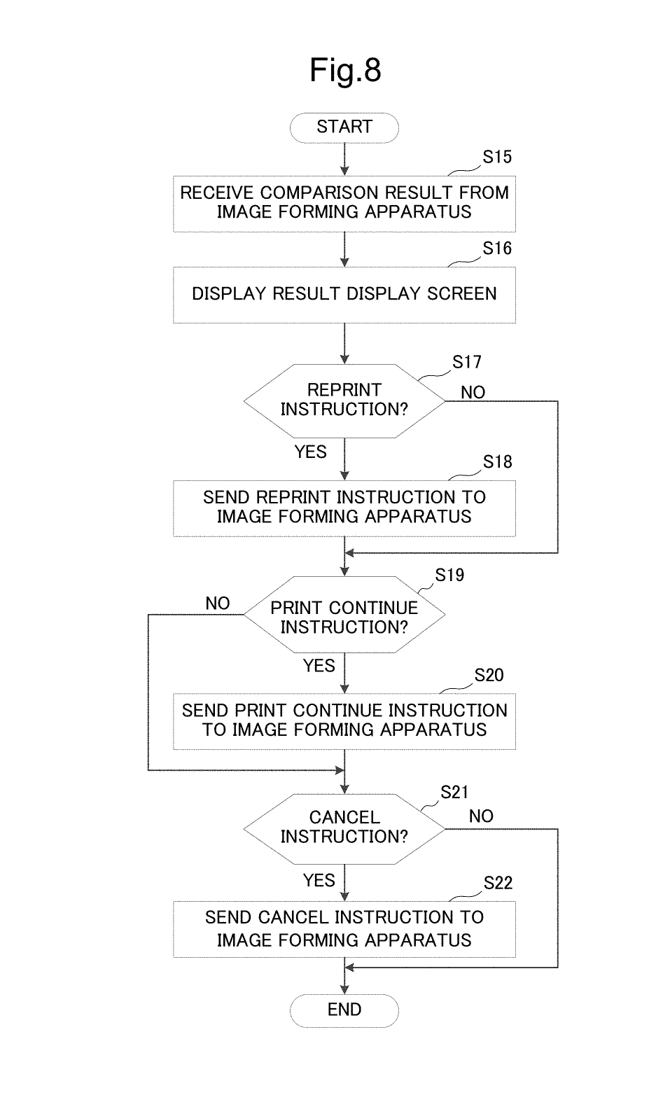

Next, a description will be given of print processing on the image forming system 100 when performing printing by sending print target data from the information processing apparatus 30 to the image forming apparatus 10. FIGS. 3 and 8 are flowcharts showing a flow of processing performed on the information processing apparatus 30 when the image forming system 100 performs the print processing. FIG. 4 is a flowchart showing a flow of processing performed on the image forming apparatus 10 when the image forming system 100 performs the print processing. FIG. 5 is a view showing an operation screen displayed on the display section 32.

When, during running of an application, such as a word processor, the user operates the operating section 33 of the information processing apparatus 30 to enter an instruction to allow the image forming apparatus 10 to print image data as a target to be processed by the application at this point in time and the instruction is accepted by the operation acceptance section 312 (YES in S1), the display control section 313 allows the display section 32 to display an operation screen D1 for entering various settings necessary for the printing, such as those shown as examples in FIG. 5 (S2). The operation screen D1 contains an image representing a plurality of tabs TB1 to TB9 indicating various print settings.

When in this state the user operates the operating section 33 to enter an instruction to select an image quality confirmation (Job Feedback) tab TB9 and the instruction is accepted by the operation acceptance section 312 (YES in S3), the display control section 313 allows an image d11 representing setting details for image quality confirmation processing associated with the Job Feedback tab TB9 to be displayed on the operation screen D1 (S4).

The image d11 contains an image quality confirmation button B1 for accepting an instruction to execute the function of confirming image quality. The image d11 further contains an allowable inclination setting value accepting image im1 for setting a threshold value for use when the image comparing section 23 of the image forming apparatus 10 determines the item-specific degree of achievement regarding the above-described degree of inclination, an allowable defect setting value accepting image im2 for setting a threshold value for use in determining the item-specific degree of achievement regarding the image defect, and an allowable sheet number setting value accepting image im3 for setting the allowable number of sheets having printing error. Also, the image d11 contains a reprint instruction accepting image im4 for accepting an instruction of whether or not to automatically reprint pages having printing error.

When in this state the user operates the operating section 33 to enter an instruction to select the allowable inclination setting value accepting image im1 and further enter a value indicating an allowable angle of inclination (YES in S5), the value is accepted by the operation acceptance section 312 (S6).

Furthermore, when the user operates the operating section 33 to enter an instruction to select the allowable defect setting value accepting image im2 and further enter a value indicating an allowable percentage of defect (YES in S7), the value is accepted by the operation acceptance section 312 (S8). Moreover, when the user operates the operating section 33 to enter an instruction to select the allowable sheet number setting value accepting image im3 and further enter a value indicating an allowable number of recording paper sheets having printing error (YES in S9), the value is accepted by the operation acceptance section 312 (S10).

In addition, when the user operates the operating section 33 to enter an instruction to select the reprint instruction accepting image im4 (YES in S11), the instruction for requesting the execution of automatic reprint is accepted by the operation acceptance section 312 (S12). In relation to the settings in S5 to S12, the control section 311 previously stores default values as initial values. Therefore, in the case where the default values are used, the entry thereof can be omitted (NO in S5, NO in S7, NO in S9 or NO in S11).

When, after these settings, the user operates the operating section 33 to select an OK button B2, contained in the operation screen D1, for accepting an instruction to perform printing, a data sending instruction to send the print target data to be printed to the image forming apparatus 10 is accepted (S13).

When the instruction to perform printing is accepted by the operation acceptance section 312, the control section 311 converts the print target data into a predetermined page-description language for the image forming apparatus 10 and controls the communication section 35 to allows the communication section 35 to send to the image forming apparatus 10 the converted print target data, a request to perform printing of the print target data, a request to perform the function of confirming printing quality, the setting values for the allowable degree of inclination, the allowable percentage of defect, and the allowable number of sheets having printing error, and if any, a request to perform automatic reprint (S14).

When in the image forming apparatus 10 the communication section 16 receives the print target data, the request to perform printing of the print target data, the request to perform the function of confirming printing quality, the setting values for the allowable degree of inclination, the allowable percentage of defect, and the allowable number of sheets having printing error, and if any, the request to perform automatic reprint (S51), the control section 21 starts a print job based on the print target data and converts image data on each page shown by the print target data into raster data (S52).

The prospective image creating section 22 first extracts, from the raster data, an image corresponding to the first page among the images of pages contained in the print target data, thus creating a prospective image (S53).

Subsequently, the control section 21 allows the image forming section 18 to print the image of the raster data corresponding to the first page (S54) and allows a recording paper sheet conveyance mechanism incorporated in the image forming apparatus 10 to start conveying the printed recording paper sheet toward the discharge section 181 (S55).

At this time, the control section 21 allows the determining image reading device 13 disposed in the conveyance path for the printed recording paper sheet from the image forming section 18 to the discharge section 181 and near the discharge port to read the printed side of the recording paper sheet (S56).

Subsequently, the image comparing section 23 compares an actual printed image of the first page represented by the image read by the determining image reading device 13 with the prospective image of the first page created by the prospective image creating section 22 to calculate comparison results indicating differences of the actual printed image from the prospective image in terms of the above-described items, i.e., the color shade, the image defect, and the degree of inclination (S57).

A description will now be given of processing for comparing the actual printed image and the prospective image performed by an image comparing section 23 in S57.

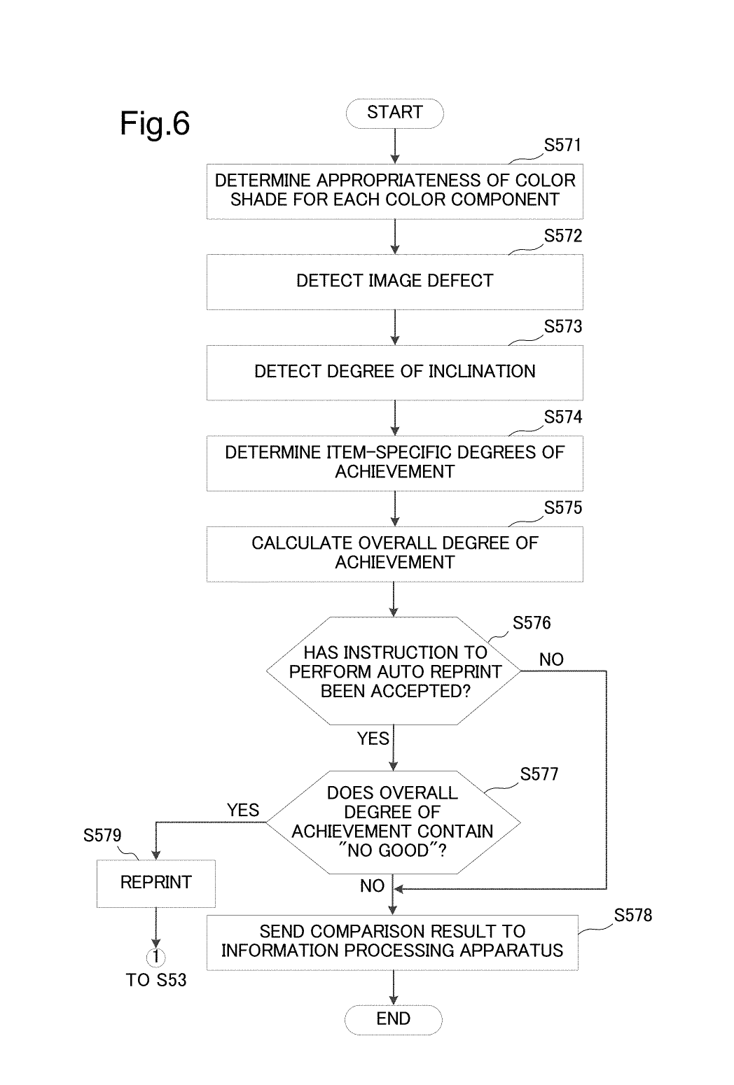

FIG. 6 is a flowchart showing the processing for comparing the actual printed image and the prospective image performed by the image comparing section 23.

First, the image comparing section 23 detects a difference in color shade between the actual printed image and the prospective image (S571).

In S571, to calculate the color shade of the actual printed image of the first page, the image comparing section 23 calculates, for each of the color components CMYK, an average pixel value of all the pixels constituting the actual printed image of the first page. Likewise, the image comparing section 23 also calculates, for each color component, an average pixel value of all the pixels constituting the prospective image. The image comparing section 23 calculates, for each color component, a difference of the average pixel value of the actual printed image from the average pixel value of the prospective image and determines the color shade for the color component to be appropriate (1) when the value indicating the difference is equal to or smaller than the predetermined threshold value or to be inappropriate (0) when the value is larger than the threshold value.

Subsequently, the image comparing section 23 detects, as a difference between the prospective image and the actual printed image, the degree of image defect of the actual printed image from the prospective image (S572). For example, the image comparing section 23 extracts, from the pixels contained in the actual printed image of the one page, any defective pixel satisfying the conditions that its pixel value is within a predetermined range of values where the pixel cannot form a dot and that the pixel value of a corresponding pixel in the prospective image is outside the predetermined range of values. The image comparing section 23 calculates, as the comparison result indicating the degree of image defect, the percentage of the number of extracted defective pixels in the total number of pixels constituting the actual printed image.

Furthermore, the image comparing section 23 detects, as a difference between the prospective image and the actual printed image, the degree of inclination of the actual printed image from the prospective image (S573). Specifically, the image comparing section 23 detects, from the actual printed image, a straight line representing one edge of a read original document by edge detection or other techniques and calculates the angle of the straight line formed with a predetermined reference line as a comparison result indicating the degree of inclination.

Then, the image comparing section 23 determines, based on the differences regarding the items obtained in S571 to S573, the respective item-specific degrees of achievement of the actual printed image from the prospective image (S574). For example, as for the item-specific degree of achievement regarding the item of color shade, if the number of determination results of “inappropriate (0)” out of the four appropriateness determination results for the four color components CMYK is equal to or larger than a predetermined value (for example, three), the image comparing section 23 determines the item-specific degree of achievement as inappropriate (0). If not, the image comparing section 23 determines the item-specific degree of achievement as appropriate (1).

Furthermore, the image comparing section 23 determines the item-specific degree of achievement regarding image defect by determining whether or not the degree of image defect exceeds the threshold value set in S8 and determines the item-specific degree of achievement regarding the degree of inclination by determining whether or not the degree of inclination exceeds the threshold value set in S6. Also for each item of image defect and the degree of inclination, the image comparing section 23 determines the actual printed image to be appropriate (1) when the degree of image defect or inclination is equal to or smaller than the threshold value, and determines the actual printed image to be inappropriate (0) when the degree of image defect or inclination exceeds the threshold value.

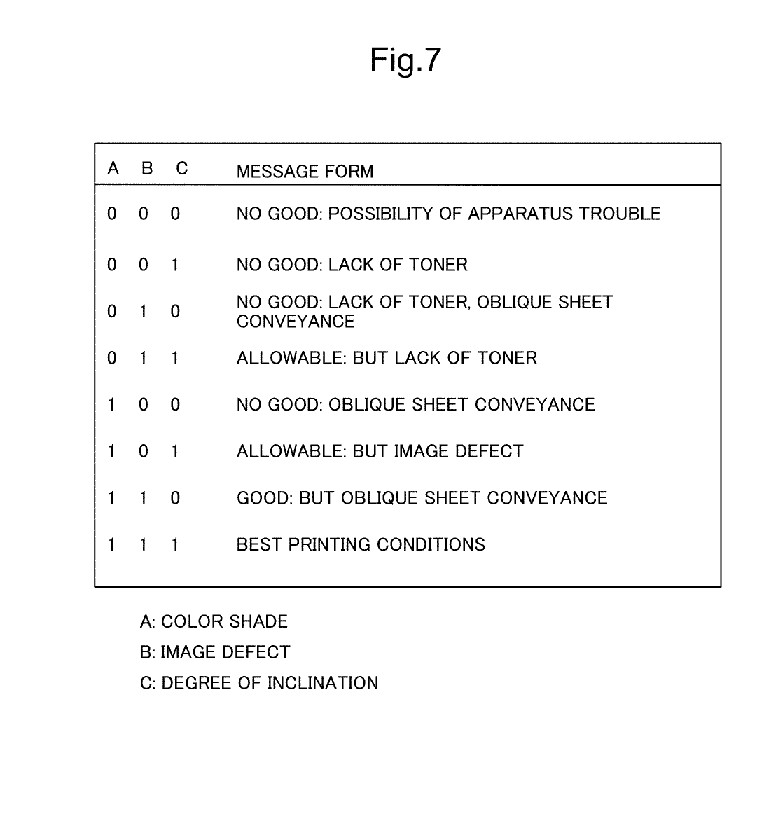

Moreover, the image comparing section 23 calculates the overall degree of achievement of the actual printed image from the prospective image (S575). For example, the image comparing section 23 previously stores a determination table shown in FIG. 7 in the form of a data table. The image comparing section 23 calculates the overall degree of achievement by reading from the determination table the overall degree of achievement corresponding to a combination of values indicating the respective item-specific degrees of achievement regarding the items. In this case, the overall degree of achievement is represented by a combination of information indicating a print condition and information indicating a predetermined cause by which it is assumed that the apparatus may make an error in image quality (and which is related to an operation of the image forming apparatus 10), such as “No Good: Possibility of Apparatus Trouble”, “No Good: Lack of Toner”, “No Good: Lack of Toner and Oblique Sheet Conveyance”, “Allowable: but Lack of Toner”, “No Good: Oblique Sheet Conveyance”, “Allowable: but Image Defect”, “Good: but Oblique Sheet Conveyance”, and “Best Printing Conditions”.

Alternatively or additionally, the image comparing section 23 may multiply the item-specific degrees of achievement regarding the items by the respective weighing factors and calculate as the overall degree of achievement the sum of the multiplied values of the item-specific degrees of achievement.

Next, the control section 21 determines whether or not an instruction for requesting the execution of automatic reprint has been accepted by the operation acceptance section 312 (S576). If the control section 21 determines that the instruction for requesting the execution of automatic reprint has not been accepted by the operation acceptance section 312 (NO in S576), the processing proceeds to S578.

On the other hand, if the control section 21 determines that the instruction for requesting the execution of automatic reprint has been accepted by the operation acceptance section 312 (YES in S576), the control section 21 further determines whether or not the overall degree of achievement calculated in S575 is a result containing “No Good”, such as “No Good: Possibility of Apparatus Trouble”, “No Good: Lack of Toner”, “No Good: Lack of Toner and Oblique Sheet Conveyance” or “No Good: Oblique Sheet Conveyance” (S577).

If the control section 21 determines that the overall degree of achievement calculated in S575 is a result containing “No Good” (YES in S577), the control section 21 allows the image forming section 18 to reprint the image of the current page being subject to calculation of the overall degree of achievement, or the first page in this case (S579). Thereafter, the processing proceeds to S53 and the pieces of processing in S53 and later steps are repeated for the next page. In this case, an after-mentioned piece of processing in S578 for sending comparison results is not performed.

Furthermore, the control section 21 counts up actual printed images having determination results containing “No Good”. If the count of actual printed images having determination results containing “No Good” exceeds the value indicating the above-described allowable number of sheets having printing error and received from the information processing apparatus 30, the control section 21 stops the print processing based on the current print target data.

On the other hand, if the control section 21 determines that the overall degree of achievement calculated in S575 is a result not containing “No Good” (NO in S577), the reprint is not performed and the processing proceeds to S578.

If NO in S576 or NO in S577, the output section 24 sends comparison results containing pieces of information obtained in S571 to S575, together with the prospective image created in S53 and the actual printed image acquired in S56, through the communication section 16 to the information processing apparatus 30 (S578).

In addition to the piece of processing in S578, the output section 24 may output the comparison results containing pieces of information obtained in S571 to S575, together with the prospective image created in S53 and the actual printed image acquired in S56, to the display section 12. In this case, the control section 21 allows the display section 12 to display the comparison results, the prospective image, and the actual printed image.

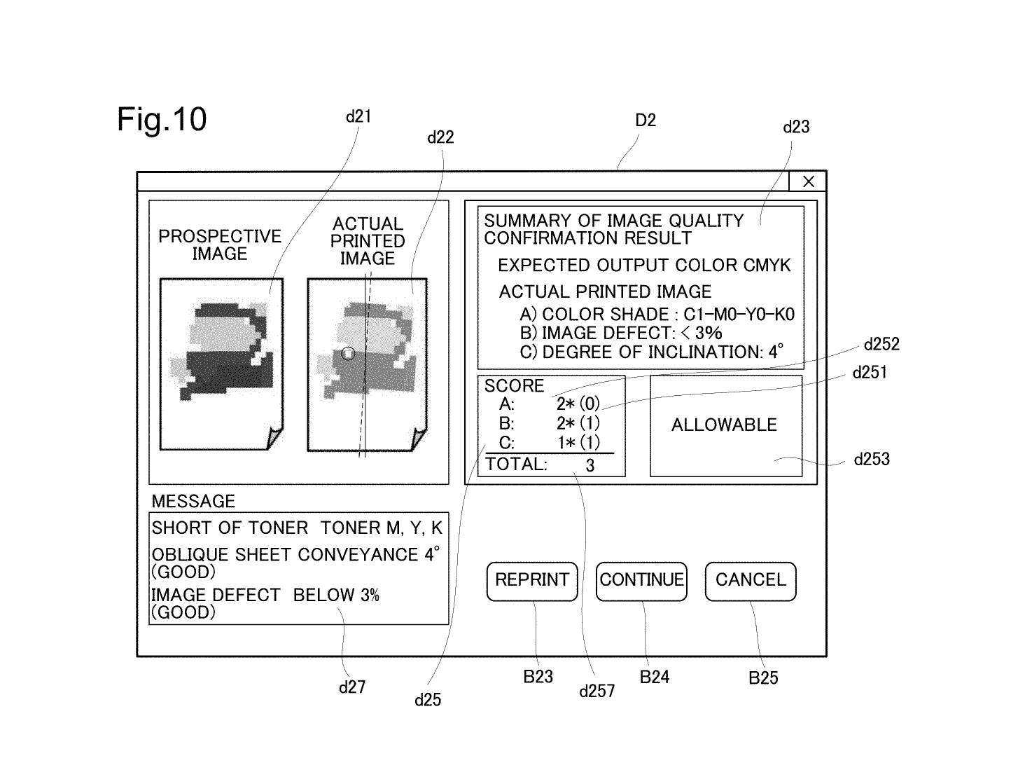

Thereafter, when in the information processing apparatus 30 the communication section 35 receives the comparison results together with the actual printed image and the prospective image from the image forming apparatus 10 (S15), the display control section 313 allows the display section 32 to display a result display screen D2 shown as an example in FIG. 10 (S16).

Here, a description will be given of the result display screen D2. The display control section 313 creates the result display screen D2 using the comparison results, the actual printed image, and the prospective image received from the image forming apparatus 10. The display control section 313 allows the display of, as the result display screen D2, an image d21 representing the received prospective image and an image d22 representing the received actual printed image. The display control section 313 also allows the display of, as a summary image d23, the values indicating the differences regarding the color shade, the image defect, and the degree of inclination, which are shown by the received comparison results. In the example shown in FIG. 10, C1-M0-Y0-K0 is shown as the value indicating the difference regarding the item of color shade, 3% is shown as the value indicating the difference regarding the item of image defect, and 4° is shown as the value indicating the difference regarding the item of degree of inclination.

Furthermore, the display control section 313 allows the display section 32 to display, within the result display screen D2, a score image d25 which contains an image d251 indicating the item-specific degrees of achievement regarding the items shown by the received comparison results, an image d252 indicating the weighting factors for the items, and an image d257 indicating the overall degree of achievement. The example shown in FIG. 10 shows the case where the item A of color shade has an item-specific degree of achievement of 0 and a weighting factor of 2 (i.e., duplation), the item B of image defect has an item-specific degree of achievement of 1 and a weighting factor of 2 (i.e., duplation), and the item C of degree of inclination has an item-specific degree of achievement of 1 and a weighting factor of 1 (unweighting). Furthermore, the example shows the case where the overall degree of achievement has been calculated as 3.

The image comparing section 23 calculates the overall degree of achievement using the weighting factors in accordance with the following formula: (overall degree of achievement)=(item-specific degree of achievement regarding color shade)*(weighting factor)+(item-specific degree of achievement regarding image defect)*(weighting factor)+(item-specific degree of achievement regarding degree of inclination)*(weighting factor). Therefore, in the above conditions, as shown in the image d257 of the result display screen D2, the image comparing section 23 calculates (overall degree of achievement of 3)=(item-specific degree of achievement of 0 regarding color shade)*(weighting factor of 2)+(item-specific degree of achievement of 1 regarding image defect)*(weighting factor of 2)+(item-specific degree of achievement of 1 regarding degree of inclination)*(weighting factor of 1). The display control section 313 allows the display section 32 to display, within the result display screen D2, the numerically indicated overall degree of achievement by an image d257.

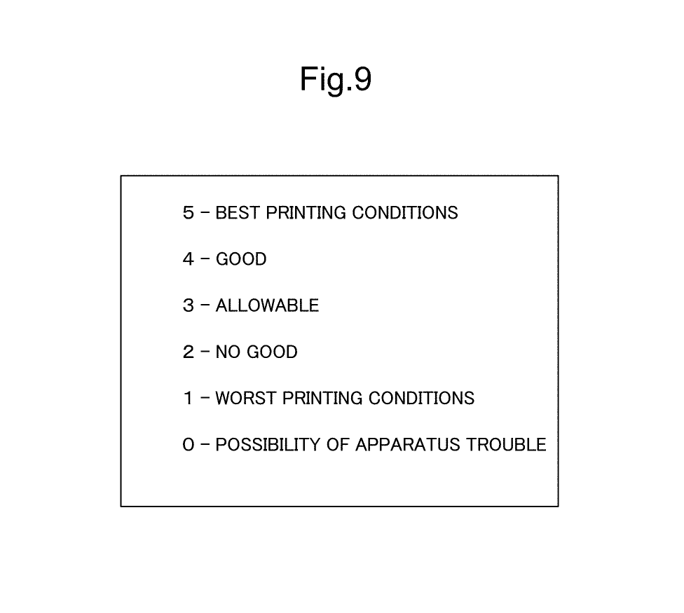

In this relation, the image comparing section 23 may previously store a corresponding table of overall degrees of achievement versus messages as shown in FIG. 9, read a message corresponding to the numerical value indicating the calculated overall degree of achievement from the table, and send the message through the communication section 16 to the information processing apparatus 30. In this case, the display control section 313 of the information processing apparatus 30 preferably allows the display section 32 to display an image d253 indicating the sent message somewhere within the result display screen D2.

Furthermore, the display control section 313 allows the display section 32 to display as a message display image d27 an image indicating messages (sent together with the comparison results from the image forming apparatus 10) associated with the values indicating the differences regarding color shade, image defect, and the degree of inclination shown by the received comparison results.

Moreover, the display control section 313 allows the display section 32 to display, within the result display screen D2, a reprint instruction acceptance button B23 for accepting a reprint instruction to reprint an image of a page for which the actual printed image and the prospective image are currently displayed in the result display screen D2, a print continue instruction acceptance button B24 for accepting a print continue instruction to continue to print subsequent pages following the page currently displayed in the result display screen D2, and a cancel button B25 for accepting a cancel instruction to cancel the current print job.

When on the result display screen D2 the reprint instruction acceptance button B23 is selected by user's operation of the operating section 33, the operation acceptance section 312 accepts a reprint instruction to reprint an image of the page currently displayed in the result display screen D2 at this point in time (YES in S17) and the communication section 35 sends the reprint instruction to reprint the page to the image forming apparatus 10 (S18).

On the other hand, when the print continue instruction acceptance button B24 is selected by user's operation of the operating section 33, the operation acceptance section 312 accepts a print continue instruction to continue to print subsequent pages following the page currently displayed in the result display screen D2 (YES in S19) and the communication section 35 sends the print continue instruction to the image forming apparatus 10 (S20).

Alternatively, when the cancel button B25 is selected by user's operation of the operating section 33, the operation acceptance section 312 accepts a cancel instruction to cancel the current print job itself (YES in S21) and the communication section 35 sends the cancel instruction to the image forming apparatus 10 (S22).

When any of the above instructions is not accepted within a predetermined period of time (for example, 10 seconds) (i.e., if all the conditions of NO in S17, NO in S19, and NO in S21 are satisfied), the control section 311 may allow the communication section 35 to send the above cancel instruction to the image forming apparatus 10.

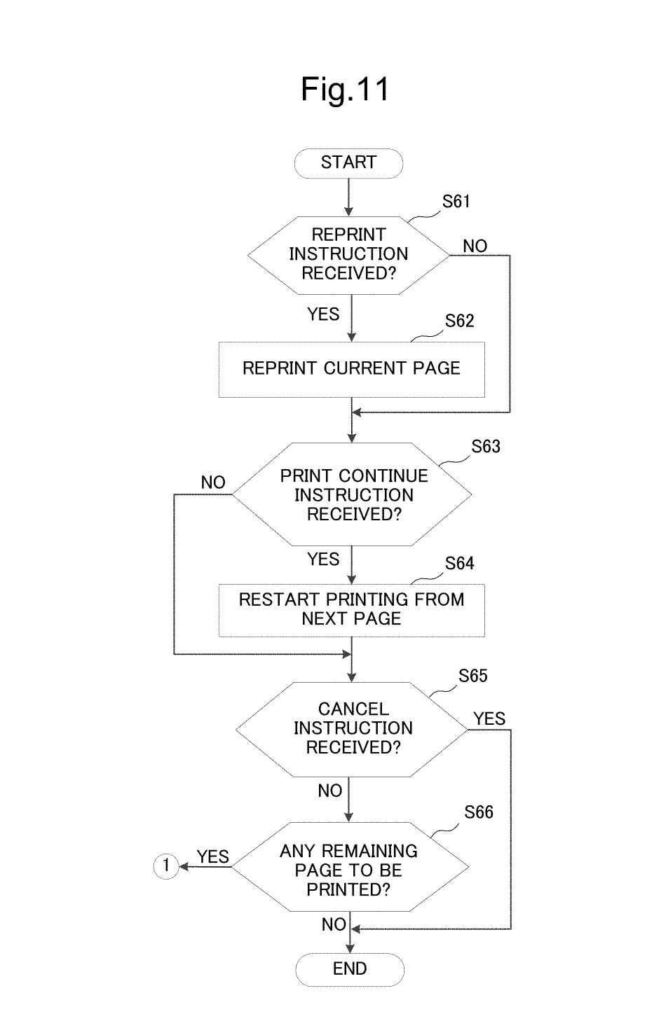

Nest, a description will be given of print processing of the image forming apparatus 10 performed after the above-described piece of processing in S57 shown in FIG. 4. FIG. 11 is a flowchart showing the print processing of the image forming apparatus 10 performed after the piece of processing in S57 shown in FIG. 4.

After the piece of processing in S57, the image forming apparatus 10 waits for any instruction from the information processing apparatus 30. When in this state the communication section 16 of the image forming apparatus 10 receives the above reprint instruction (YES in S61), the control section 21 allows the image forming section 18 to print again the page indicated as an object of reprint by the reprint instruction, i.e., the first page in this case, using the raster data (S62).

On the other hand, when the communication section 16 receives the print continue instruction (NO in S61 and YES in S63), the control section 21 allows the image forming section 18 to restart printing from the page next to a page (pages) already printed at this point in time, i.e., the second page in this case, using the raster data (S64).

Alternatively, when the communication section 16 receives the cancel instruction (NO in S61, NO in S63, and YES in S65), print processing for the next and subsequent pages based on the current print job is not performed and processing for the current print job is terminated.

When the communication section 16 does not receive any of the above instructions (NO in S61, NO in S63, and NO in S65) and the control section 21 determines that there is any remaining page to be printed for the print target data (YES in S66), the processing goes back to S53 shown in FIG. 4 and the pieces of processing in S53 and later steps are repeated for the next page. Then, at the time when the control section 21 determines that there is no remaining page to be printed (NO in S66), the processing for the current print job is terminated.

According to this embodiment, every time the image forming apparatus 10 completes printing of one page, the actual printed image is compared with the prospective image in terms of predetermined items related to printing quality, i.e., color shade, image defect, and the degree of inclination in this embodiment, and the comparison results are sent from the image forming apparatus 10 to the information processing apparatus 30, which enables the user to recognize the printing quality for the current print job at the point in time. Therefore, the user can easily know the image quality of a print without the need to go to the installation place of the image forming apparatus 10 and visually check the print.

Furthermore, in this embodiment, the display of the information indicating the overall degree of achievement contains a message relating to a mechanism and/or a supply (such as toner or recording paper sheet) for the image forming apparatus 10 which caused the comparison results. Therefore, the user can confirm the message to utilize it for analysis of the operation or trouble of the image forming apparatus 10.

Moreover, in this embodiment, not only an actual printed image is acquired from a print itself based on print target data but also a prospective image is created from the print target data. Therefore, without the need to make a test print or the like and scan it, the image quality of the print based on the print target data can be evaluated.

In this embodiment, the comparison results of the actual printed image with the prospective image in terms of color shade, image defect, and the degree of inclination can be understood from values indicating the appropriateness or information indicated as the overall degree of achievement. Therefore, it can be easily determined whether the causes of the comparison results are related to, for example, the image forming apparatus 10.

As thus far described, according to this embodiment, differences of an image of an actual print from a desired image expected as a printing result can be detected without the need to make a test print.

For example, the one technique disclosed in BACKGROUND merely determines a poorly printed region on a printed medium and, therefore, cannot detect the appropriateness of printing quality of the image forming apparatus used in printing. In contrast, according to the above embodiment, it is possible even to detect the appropriateness of printing quality of the image forming apparatus used in printing. Furthermore, the other technique disclosed in BACKGROUND can examine a variation in color shade between prints made by the image forming apparatus, but the examination requires a test print. In contrast, according to this embodiment, differences of an image of an actual print from a desired image expected as a printing result can be detected without the need to make a test print.

The present disclosure is not limited to the configurations of the above embodiment and can be modified in various ways. For example, in the above embodiment, when the image comparing section 23 makes the above-described determination of the overall degree of achievement for the image of the first page, it sends the determination result through the communication section 16 to the information processing apparatus 30 and the display section 32 of the information processing apparatus 30 displays the determination result as part of the result display screen D2. Alternatively, if the determination result of the overall degree of achievement based on S575 shown in FIG. 6 is, for example, at the lowest level where all the items are inappropriate “0”, the control section 21 may terminate print processing based on the current print job at the point in time in addition to or in place of sending of the overall degree of achievement through the communication section 16 to the information processing apparatus 30. If the overall degree of achievement is at the lowest level, this indicates that the image forming apparatus 10 is faulty in terms of all the items of color shade, image defect, and the degree of inclination and is highly likely to cause some troubles. Therefore, the control section 21 stops the print processing of the image forming apparatus 10 based on the print target data.

Furthermore, when the second determination result of the overall degree of achievement in S575 for the image of a page determined to be a page to be reprinted in S62 is “inappropriate” again as with the previous determination result, the control section 21 may send an instruction to display a message indicating that there is something wrong with the image forming apparatus 10 (inclusive of a message prompting the execution of inspection of the image forming apparatus 10) through the communication section 16 to the information processing apparatus 30 or, at this point in time, terminate the print processing based on the current print target data.

The structure, configuration, and processing described in the above embodiment with reference to FIGS. 1 to 11 are merely illustrative and are not intended to limit the present disclosure to them.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. An image forming apparatus comprising:
a print target data acquisition section that acquires print target data from an information processing apparatus;
a printing section that performs printing on a recording medium based on the print target data acquired by the print target data acquisition section;
an actual printed image acquisition section that reads an image from the recording medium on which the printing has been performed by the printing section and acquires the read image as an actual printed image;
a prospective image creating section that creates from the print target data a prospective image expected to be provided by the printing on the image forming apparatus;
an image comparing section that compares the actual printed image acquired by the actual printed image acquisition section with the prospective image created by the prospective image creating section to calculate a comparison result indicating a difference of the actual printed image from the prospective image in terms of a predetermined item related to printing quality of the printing section; and
an output section that outputs the comparison result regarding the item calculated by the image comparing section.

2. The image forming apparatus according to claim 1, wherein the actual printed image acquisition section is an image reading device that reads, downstream of the printing section in a direction of conveyance in which the recording medium is discharged, the recording medium on which the printing has been performed by the printing section.

3. The image forming apparatus according to claim 1, wherein the output section outputs the comparison result to the information processing apparatus.

4. The image forming apparatus according to claim 1,
further comprising a display section,
wherein the output section outputs the comparison result to the display section.

5. The image forming apparatus according to claim 1, wherein the image comparing section calculates the comparison result using as the item at least one of a plurality of items including a color shade, a defect, and a degree of inclination of the image.

6. The image forming apparatus according to claim 5, wherein
the image comparing section determines a degree of achievement of the actual printed image from the prospective image based on whether or not the comparison result regarding the item reaches a predetermined threshold value, and
the output section outputs the degree of achievement as a portion of the comparison result to the information processing apparatus.

7. The image forming apparatus according to claim 6, wherein
the image comparing section determines the respective degrees of achievement regarding the plurality of items and determines, on the basis of the degrees of achievement regarding the plurality of items, an image quality level of the printing based on the actual printed image, and
the output section outputs the image quality level as a portion of the comparison result to the information processing apparatus.

8. The image forming apparatus according to claim 6, wherein
the image comparing section determines the respective degrees of achievement regarding the plurality of items, assigns respective weighting factors to the plurality of items, multiplies the respective degrees of achievement regarding the plurality of items by the respective weighting factors, and determines, on the basis of a sum of values obtained by multiplying the respective degrees of achievement by the respective weighting factors, an image quality level of the printing based on the actual printed image, and
the output section outputs the image quality level as a portion of the comparison result to the information processing apparatus.

9. The image forming apparatus according to claim 1, wherein
the print target data contains images of a plurality of pages, and
when, during printing of the images of the plurality of pages on a plurality of recording media by the printing section, the image comparing section determines that an image quality level of the actual printed image on a recording medium corresponding to one of the plurality of pages is below a predetermined standard, printing of the remaining pages is stopped.

10. The image forming apparatus according to claim 1, wherein when the image comparing section determines that an image quality level of a page reprinted by the printing section is below a predetermined standard, the output section outputs a message indicating that there is something wrong with a condition of the image forming apparatus, together with the comparison result of the image comparing section, to the information processing apparatus.

11. An image forming system including an information processing apparatus and an image forming apparatus,
the image forming apparatus comprising:
a print target data acquisition section that acquires a print target data from the information processing apparatus;
a printing section that performs printing on a recording medium based on the print target data acquired by the print target data acquisition section;
an actual printed image acquisition section that reads an image from the recording medium on which the printing has been performed by the printing section and acquires the read image as an actual printed image;
a prospective image creating section that creates from the print target data a prospective image expected to be provided by the printing on the image forming apparatus;
an image comparing section that compares the actual printed image acquired by the actual printed image acquisition section with the prospective image created by the prospective image creating section to calculate the comparison result indicating a difference of the actual printed image from the prospective image in terms of a predetermined item related to printing quality of the printing section; and
an output section that outputs the comparison result regarding the item calculated by the image comparing section,
the information processing apparatus comprising:
a print target data sending section that sends the print target data to the image forming apparatus;
a comparison result receiving section that receives the comparison result from the image forming apparatus; and
a display device that displays the comparison result received by the comparison result receiving section.
